(19) United States
(12) Patent Application Publication
(10) Pub. No.: US 2017/0249192 A1
(43) Pub. Date: Aug. 31, 2017

(54) DOWNLOADING VISUAL ASSETS

(71) Applicant: Microsoft Technology Licensing, LLC, Redmond, WA (US)

(72) Inventor: Eric Thompson, Seattle, WA (US)

(21) Appl. No.: 15/055,057

(22) Filed: Feb. 26, 2016

(51) Int. Cl. G06F 9/50; G06F 17/30

(52) U.S. Cl. CPC G06F 9/5038; G06F 17/3053; G06F 9/505

(57) ABSTRACT

Techniques and technologies for downloading visual assets are described. In at least some embodiments, a system includes a plurality of visual assets stored on at least one memory, the plurality of visual assets associated with a plurality of workloads, and an asset registry including information regarding prior usage of the plurality of workloads. The asset registry is configured to determine a priority ranking of a plurality of n workloads based at least partially on the prior usage of the plurality of workloads; facilitate downloading of one or more visual assets associated with the plurality of n workloads based on the priority ranking; and facilitate downloading of one or more visual assets associated with one or more remaining workloads of the plurality of workloads at a reduced priority transmission rate compared with a nominal transmission rate associated with the downloading of the plurality of n workloads.

### BACKGROUND

A contemporary approach to providing software applications is to host such applications on one or more hosting devices (e.g. servers) that are centrally managed, and then allow users to access such applications from any desired location using client devices via one or more networks. The networks may be relatively limited in extent, such as a company intranet, or may be far-reaching (e.g. global) such as the Internet. This approach provides relative ease of management, as well as ensuring that users are provided with the latest and most capable application version, however, it also places an increased demand on network capabilities (e.g. bandwidth, processing speed, etc.).

Typically, when a user begins to interact with a desired application, one or more portions of the application are downloaded from a hosting device onto the user's client device via the network, and may be temporarily or permanently stored in the memory of the client device. Issues associated with downloading applications may be most prevalent the first time that an application is loaded onto a new client device, or when a new browser is invoked by the user, or when a browser with a freshly cleaned cache is invoked. As a user switches from one application to another application, or from workload to workload in the same application, one or more portions of the new application may be required to be downloaded, such that the user may experience delays and network capabilities may be heavily burdened. Ideally, all visual assets associated with a particular application would be downloaded and cached so that the whole set of visual assets is available as needed, however, this would result is a massive initial downloading delay when the application is initially accessed.

### SUMMARY

In at least some embodiments, a system for downloading visual assets includes a plurality of visual assets stored on at least one memory, the plurality of visual assets associated with a plurality of workloads; an asset registry including information regarding prior usage of the plurality of workloads, the asset registry being configured to: determine a priority ranking of a plurality of n workloads of the plurality of workloads based at least partially on the prior usage of the plurality of workloads, where n is less than a total number of workloads in the plurality of workloads; facilitate downloading of one or more visual assets associated with the plurality of n workloads based on the priority ranking; and facilitate downloading of one or more visual assets associated with one or more remaining workloads of the plurality of workloads at a reduced priority transmission rate compared with a nominal transmission rate associated with the downloading of the plurality of n workloads.

In another implementation, a system for downloading visual assets includes a control component including at least one processing component; at least one memory operatively coupled to the control component; a plurality of visual assets stored on the at least one memory, each visual asset of the plurality of visual assets being associated with at least one workload of a plurality of workloads; and a registry stored on the at least one memory, the registry including information regarding prior usage of the plurality of workloads; wherein the control component is configured to: determine a need to download one or more visual assets associated with the plurality of workloads; determine a priority ranking of a plurality of n workloads of the plurality of workloads based at least partially on the prior usage of the plurality of workloads, where n is less than a total number of workloads in the plurality of workloads; download one or more visual assets associated with the plurality of n workloads based on the priority ranking at a nominal transmission rate; and download one or more visual assets associated with one or more remaining workloads of the plurality of workloads at a reduced priority transmission rate compared with the nominal transmission rate associated with the downloading of the plurality of n workloads.

And in still other implementations, one or more computer-readable media bearing one or more instructions that, when executed by one or more processing components, perform operations for downloading visual assets, the operations comprising: determining a need to download one or more visual assets associated with a plurality of workloads of one or more applications; determining a priority ranking of a plurality of n workloads of the plurality of workloads based at least partially on prior usage of the plurality of workloads, where n is less than a total number of workloads in the plurality of workloads; downloading one or more visual assets associated with the plurality of n workloads based on the priority ranking at a nominal transmission rate; and downloading one or more visual assets associated with one or more remaining workloads of the plurality of workloads at a reduced priority transmission rate compared with the nominal transmission rate associated with the downloading of the plurality of n workloads.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the use of the same reference numbers in different figures indicates similar or identical components.

FIG. 1 shows an embodiment of an environment for downloading visual assets for applications.

FIG. 2 shows an embodiment of a process for downloading visual assets for applications.

FIG. 3 shows an embodiment of a system for downloading visual assets for applications in a first operating condition.

FIG. 4 shows the system of FIG. 3 in a second operating condition.

FIG. 5 shows another embodiment of a process for downloading visual assets for applications.

FIG. 6 shows an embodiment of a computer system environment for downloading visual assets for applications.

### DETAILED DESCRIPTION

The present disclosure describes techniques and technologies for downloading visual assets for software applications. As described more fully below, techniques and technologies for downloading visual assets in accordance with the present disclosure may assess actual and probable demands on network capabilities associated with downloading visual assets for applications, and may advantageously perform downloading of such visual assets in an effective and efficient manner.

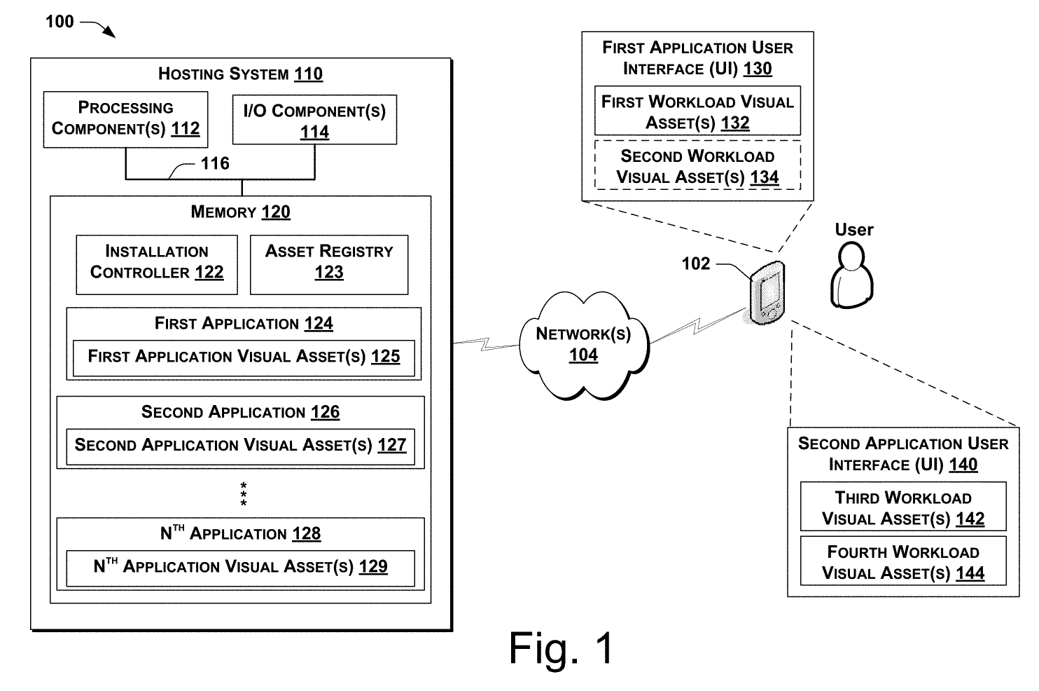

FIG. 1 shows an embodiment of an environment 100 for downloading visual assets for applications in accordance with the present disclosure. In this embodiment, the environment 100 includes a hosting system 110 that includes one or more processing components 112 and one or more input/output (I/O) components 114 operatively coupled to a memory 120 by a bus 116. A downloading controller 122 and an asset registry 123 are stored on the memory 120. The hosting system 110 hosts a plurality of software applications for access by a client device 102 via one or more networks 104 (e.g. using the one or more I/O components 114). For example, in the embodiment shown in FIG. 1, the hosting system 110 includes a first application 124, a second application 126, and an n^{th} application 128 stored on the memory 120.

The user device 102 enables a user to access and operate one or more of the applications 124, 126, 128 available on the hosting system 110. It will be appreciated that each of the applications 124, 126, 128 may enable the user to perform a variety of tasks and operations, and that such tasks and operations represent different “workloads” to the respective applications 124, 126, 128.

As shown in FIG. 1, each of the applications 124, 126, 128 includes one or more visual assets, which may be symbols, shapes, icons, or other suitable items that are displayable by a user interface (UI) of the application when the user invokes the application on the user device 102. More specifically, the first application 124 includes one or more first application visual assets 125, the second application 126 includes one or more second application visual assets 127, and the n^{th} application 128 includes one or more n^{th} application visual assets 129. In some implementations, there may be at least some commonality between the visual assets of the applications 124, 126, 128, while in other implementations, there may be no commonality between the visual assets of the applications 124, 126, 128.

The downloading controller 122 controls the downloading of one or more portions (or all) of the first, second, and n^{th} applications 124, 126, 128 onto the client device 102 as needed, such as a first time that an application is loaded onto a new client device, or when a new browser is invoked by the user, or when a browser with a freshly cleaned cache is invoked. Similarly, the downloading controller 122 may control such operations as patching, refreshing, and updating operations after an application has been loaded on the client device 102.

The asset registry 123 includes information used by the downloading controller 122 for performing the operations of the downloading controller 122, including the downloading of one or more portions of the first, second, and n^{th} applications 124, 126, 128 onto the client device 102. More specifically, in at least some implementations, the asset registry 123 may include configuration information that includes all of the visual assets required by each of the applications 124, 126, 128. In addition, the asset registry 123 may include information regarding the subsets of one or more visual assets required by each possible workload of each of the applications 124, 126, 128.

In at least some implementations, the asset registry 123 may further include information regarding past usage of at least some of the workloads of the applications 124, 126, 128. For example, in at least some implementations, the asset registry 123 may include information regarding the most frequently or heavily used workloads of the applications 124, 126, 128. This may include information indicating the most frequently used workloads of each of the applications 124, 126, 128. In at least some implementations, the most frequently used n workloads (where n>1) of each of the applications 124, 126, 128 may be known or determined for a particular user, or may be known based on past usage of the applications 124, 126, 128 by some or all previous users.

As depicted in FIG. 1, when the user is operating the first application 124 on the client device 102, the client device 102 displays a first application user interface (UI) 130. In this embodiment, the first application UI 130 includes first workload visual assets 132 associated with a first workload of the first application 122. For example, if the first application 124 represents a word processing application (e.g. Microsoft Word®), then the first workload visual assets 132 may be one or more icons that are displayed in a toolbar portion of the first application UI 130 associated with the first workload, which may involve one or more word processing tasks or operations (e.g. copying, pasting, cutting, format painting, etc.).

As further shown in FIG. 1, the first application UI 130 may include second workload visual assets 134 associated with a second workload of the first application 124. For example, still assuming that the first application 124 represents a word processing application, the second workload visual assets 134 may be one or more icons that are displayed in another toolbar portion of the first application UI 130 associated with a second set of one or more word processing tasks or operations (e.g. inserting a page break, table, picture, clip art, shape, etc.).

In at least some implementations, the second workload visual assets 134 (shown in dotted lines in FIG. 1) are not displayed simultaneously by the first application UI 130 with the first workload visual assets 132, but rather, when the user selects a second workload, the first application UI 130 may change from displaying the first workload visual assets 132 to displaying the second workload visual assets 134. Alternately, in at least some implementations, the second workload visual assets 134 may be displayed at the same time (i.e. simultaneously) with the first workload visual assets 132. For example, if the user selects a particular one of the first workload visual assets 132, the second workload visual assets 134 may appear and be displayed simultaneously with the first workload visual assets 132 to enable the user to perform the second workload.

In similar fashion, when the second application 126 is operating on the client device 102, the client device 102 may display a second application user interface (UI) 140. In the embodiment shown in FIG. 1, the second application UI 140 includes third workload visual assets 142 associated with a third workload of the second application 126, and fourth workload visual assets 144 associated with a fourth workload of the second application 126. For example, if the second application 126 represents an application for creating drawings (e.g. Microsoft Visio®), then the third workload visual assets 142 may be one or more icons that are displayed in a toolbar portion of the second application UI 140 associated with the third workload, which may involve one or more drawing tasks or operations (e.g. line drawing, line thickness, arrows, arcs, etc.), while the fourth workload may involve one or more shape-related tasks or operations (e.g. vertical alignment, horizontal alignment, shading, fill type, fill color, etc.).

In at least some implementations, the client device 102 may display the second application UI 140 simultaneously with the first application UI 130. Alternately, in at least some implementations, the client device 102 may only display either the first application UI 130 or the second application UI 140 at a time, and may not display the first application UI 130 and the second application UI 140 simultaneously. Furthermore, as noted above with respect to the first application UI 130, in at least some implementations, the second application UI 140 may display the third and fourth workload visual assets 142, 144 simultaneously, while in some other implementations, the second application UI 140 may display either the third workload visual assets 142 or the fourth workload visual assets 144, but not both simultaneously.

It will be appreciated that the hosting system 110 shown in FIG. 1 may represent a variety of possible system types, including but not limited to a server, a mainframe, a workstation, a distributed computing system, a cloud-based computing system, or any other suitable type of system. Similarly, although the user device 102 is depicted in FIG. 1 as being a handheld device, such as a cellular telephone, it will be appreciated that in alternate embodiments, the user device 102 may be any suitable device that enables a user to access and operate one or more of the applications 124, 126, 128. For example, in alternate embodiments, the user device 102 may be a Personal Data Assistant (PDA), notebook computer, tablet computer, laptop computer, desktop computer, server or mainframe computer, a television, a wristwatch, a wearable device, a vehicle, an appliance, a consumer product, or virtually any other suitable device.

The one or more networks 106 may comprise any suitable topology of servers, clients, Internet service providers, or other suitable communication media (e.g., a LAN, WAN, a local communication system, a global communication system, the Internet, a cellular communication system, a telephonic communication system, etc.). In various implementations, the one or more networks 106 may have a static or dynamic topology, and may include a secure network (e.g., an enterprise network), an unsecure network (e.g., a wireless open network, the Internet, etc.), and may also coordinate communication over other networks (e.g., PSTN, cellular networks, etc.). By way of example, and not limitation, the one or more networks 106 may be coupled by any suitable communication technologies, including, for example, electromagnetic signals, acoustic signals, RF signals, infrared signals and any other suitable communication technologies or signals.

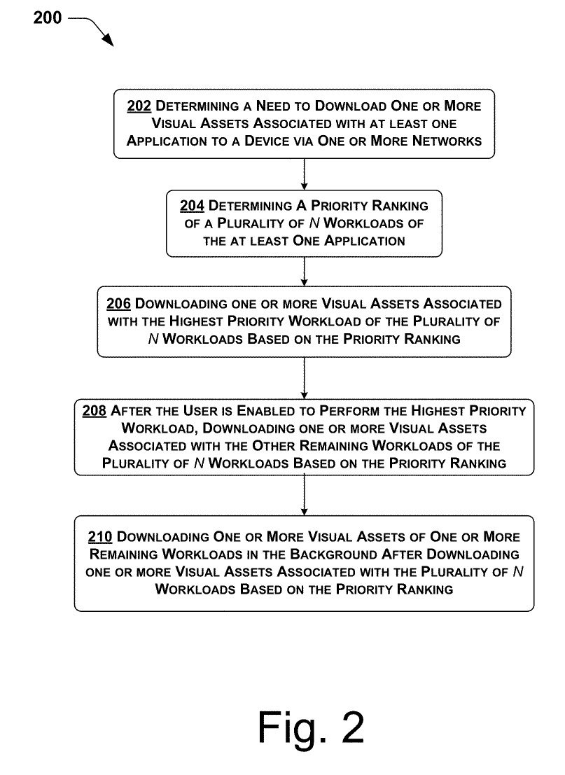

FIG. 2 shows an embodiment of a process 200 for downloading visual assets for applications in accordance with the present disclosure. In this embodiment, the process 200 includes determining a need to download one or more visual assets associated with at least one application to a device via one or more networks at 202. For example, in at least some implementations, the determining a need to download one or more visual assets at 202 may occur a first time that an application is loaded onto a new client device, or when a new browser is invoked by the user, or when a browser with a freshly cleaned cache is invoked.

The process 200 further includes determining a priority ranking of a plurality of n workloads of the at least one application at 204, wherein n is less than a total number of workloads associated with the at least one application. For example, the determining of the workload priority ranking at 204 may include the downloading controller 122 of the hosting system 110 determining a ranking of the top n workloads of a first application (e.g. n=3, n=6, etc.). In another example, the determining of the workload priority ranking at 204 may include determining a priority ranking of the top n=i+j workloads, where i is a number of workloads associated with a first application, and j is a number of workloads associated with a second application, and then determining a ranking of the n workloads of the first and second applications (e.g. n=2, n=5, n=8, etc.).

In at least some implementations, the determining of the workload priority ranking at 204 may be based on usage frequency, usage volume, one or more usage patterns, or any other suitable factors. For example, in at least some implementations, one or more usage patterns may indicate that some workloads are used during one period of a day (e.g. email applications more frequently used during normal working hours), while other workloads are used during other periods of the day (e.g. social networking applications more frequently used during non-working hours). Alternately, one or more usage patterns may indicate that some workloads are often used by a particular user in a particular pattern (e.g. on work days an email application is used first, then a browsing application used, then a word processing application used, etc.). Of course, any other suitable usage patterns may be conceived that may be employed in the determining of the workload priority ranking at 204.

In at least some implementations, the determining of the workload priority ranking at 204 may include the downloading controller 122 of the hosting system 110 examining usage history information associated with prior application usage by the user to determine the user's individual preferences, habits, or previous usage history, and determining the priority ranking of the plurality of workloads of the at least one application based on the individual usage history information associated with the user. Alternately, in at least some other implementations, the determining of the workload priority ranking at 204 may include examining general usage history information associated with prior application usage by some or all previous users of the one or more applications accessible on the hosting system 110. In at least some implementations, the usage history information associated with either the user's individual prior application usage, or the application usage of some or all previous users, or both, may be stored in the asset registry 123.

Furthermore, in at least some applications, the determining of the priority ranking of the plurality of workloads at 204 may include the downloading controller 122 determining whether a user has selected a particular workload that requires one or more visual assets to be downloaded (e.g. by indicating a selection via one or more application user interfaces 130, 140 on a client device 102), and if so, then ranking the user-selected particular workload as the highest priority workload (i.e. priority ranking of “1”). The remainder of the priority ranking of the plurality of workloads at 204 may then be based on the user's individual usage history, or on general usage history of one or more users, or using any other suitable techniques, information, or operations.

With continued reference to FIG. 2, the process 200 for downloading visual assets for applications further includes downloading one or more visual assets associated with the highest priority workload of the plurality of workloads based on the priority ranking at 206, and then after the user is enabled to perform the highest priority workload, downloading one or more visual assets associated with the other remaining workloads of the plurality of n workloads at 208. In at least some implementations, the plurality of n workloads may be from a single one of the available applications 124, 126, 128, or may be from two or more of the available applications 124, 126, 128. For example, based on the user's individual usage history, or on general usage history of one or more users, or using any other suitable techniques, information, or operations, the plurality of n workloads may include two workloads from the first application (e.g. a word processing application), three workloads from the second application (e.g. a visual presentation application), and one workload from the n^{th} application (e.g. a spreadsheet application). Of course, any other combination of the n highest priority workloads from the plurality of available applications on the hosting system 110 may be determined.

For example, in at least some implementations, the downloading controller 122 may establish a priority ranking of a particular workload selected by a user and three other workloads for a total of four highest priority workloads, with the user-selected particular workload ranked as the highest priority workload. The application being invoked by the user may, of course, have an overall capability of performing tens, hundreds, thousands, or any other suitable number of different workloads. The downloading controller 122 may then download (at 206) one or more visual assets associated with the user-selected particular workload as the highest priority workload to the client device 102 at a data transfer rate associated with normal priority (or higher priority) data transfers on the one or more networks 104. Once the downloading by the downloading controller 122 (at 206) has enabled the user to perform the highest priority workload on the client device 102, the downloading controller 122 may then continue to download one or more visual assets associated with the other three highest priority workloads at the same data transfer rate (normal or high priority) to enable the user to immediately invoke the other three highest priority workloads without experiencing downloading delays.

As further shown in FIG. 2, the process 200 further includes downloading one or more visual assets of one or more remaining workloads in the background (or at a reduced data transfer rate associated with lower priority transfers) after downloading one or more visual assets associated with the n highest priority workloads based on the priority ranking at 210. For example, continuing with the previously described example, after the downloading controller 122 has downloaded the visual assets associated with the four highest priority workloads, the downloading controller 122 may continue to download the visual assets of all remaining workloads of the application in the background while the user operates the user-selected particular workload of the application on the client device 102, or at least while the one or more workloads associated with the previously downloaded visual assets are enabled to be operated on the client device 102.

It will be appreciated that techniques and technologies for downloading visual assets for applications as disclosed herein may provide substantial operational improvements in comparison with conventional technologies. For example, processes for downloading visual assets in accordance with the present disclosure may advantageously manage and distribute the downloading operations to substantially reduce the network burdens and computational resources associated with enabling access to applications via one or more networks.

More specifically, such techniques can advantageously reduce the initial downloading requirements associated with the downloading for visual assets for applications that might otherwise be experienced using conventional techniques and technologies, particularly during such events as the first time that an application is loaded onto a new client device, or when a new browser is invoked by the user, or when a browser with a freshly cleaned cache is invoked. Because the visual assets are prioritized and downloaded according to the prioritization, with some highest priority visual assets being downloaded immediately while other lower priority visual assets are downloaded in the background for eventual use, the techniques and technologies disclosed herein may reduce network demands and requirements by immediately enabling the user to employ the highest priority workloads of the available applications, while also delaying the downloading of the lower priority assets until a later time when network demands may be less strained. In this way, a user may be more quickly enabled to use the highest priority workloads of the application, without experiencing the delays that might otherwise be experienced associated with the downloading of all necessary visual assets associated with all possible workloads. Thus, the burdens on the network associated with downloading visual assets may be appropriately distributed, freeing up network resources for higher priority network traffic, such as the traffic associated with the workloads of the applications being performed by the user on the client device.

Techniques and technologies for downloading visual assets for applications in accordance with the present disclosure are not necessarily limited to the particular embodiments described above with reference to FIGS. 1-3. In the following description, additional embodiments of techniques and technologies for downloading visual assets for applications will be described. It should be appreciated that the embodiments described herein are not intended to be exhaustive of all possible embodiments in accordance with the present disclosure, and that additional embodiments may be conceived based on the subject matter disclosed herein. For example, it should be appreciated that at least some of the various components and aspects of the described embodiments may be eliminated to create additional embodiments, or may be variously combined or re-ordered to create still further embodiments. In the following discussion of additional embodiments, common reference numerals may be used to refer to elements introduced above, and for the sake of brevity, descriptions of previously-introduced elements may be omitted so that emphasis can be properly placed on new or varying aspects of such additional embodiments.

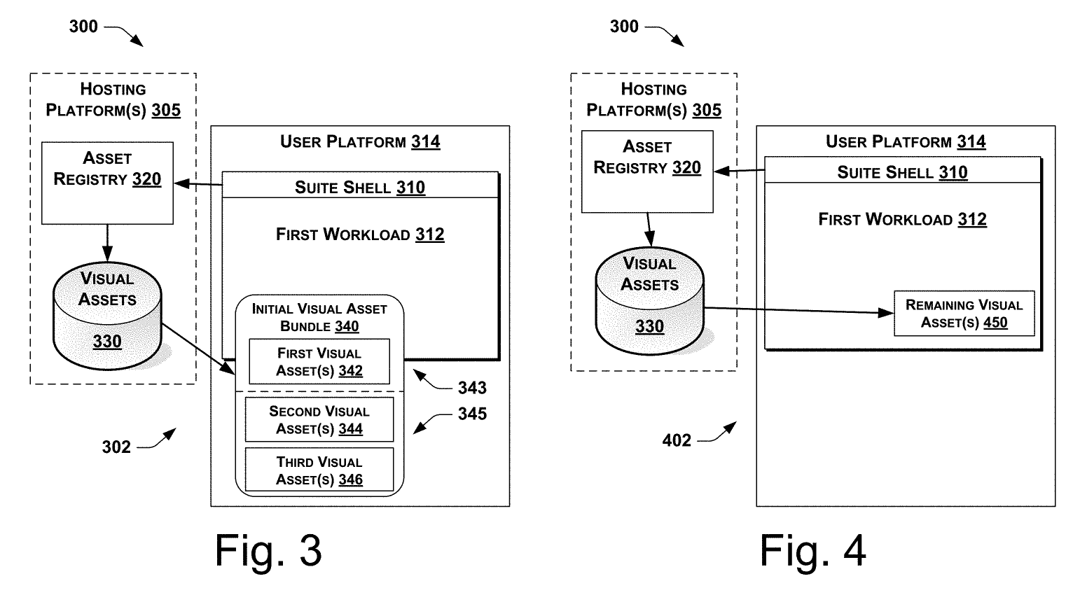

FIG. 3 shows another embodiment of a system 300 for downloading visual assets for applications. In this embodiment, the system 300 includes an asset registry 320 and a database of visual assets 330 operating on one or more hosting platforms 305. A suite shell 310 operating on a user platform 314 provides a user interface from which a user may select one or more available applications for use. As noted above, in at least some implementations, the asset registry 320 may include information regarding the most frequently or heavily used workloads of the applications that are available for use. For example, the asset registry 320 may include information indicating the most frequently used workloads for one or more available applications for a particular user (e.g. based on usage history), or for some or all previous users. In addition, in at least some implementations, the asset registry 320 may be configured to perform one or more of the operations described above as being associated with or performed by the installation controller 122 of FIG. 1.

In a first operating condition 302, a first workload 312 may be initiated on the user platform 314, such as when a user makes a selection of at least one application, or at least one workload of an application, via the suite shell 310. The asset registry 320 may perform a process of downloading visual assets for applications in accordance with the present disclosure, including prioritizing a plurality of n workloads (where n>1), and downloading one or more visual assets from the database of visual assets 330 according to the prioritization, as described more fully below.

As further shown in FIG. 3, in at least some implementations, in the first operating condition 302, an initial visual asset bundle 340 may be downloaded from the database of visual assets 330 to the platform 314 operating the first workload 312. In the implementation shown in FIG. 3, the initial visual asset bundle 340 includes one or more first visual assets 342, one or more second visual assets 344, and one or more third visual assets 346. The initial visual asset bundle 340 may include a first portion 343 containing the one or more first visual assets 342, and a second portion 345 containing the one or more second visual assets 344, and the one or more third visual assets 346. In at least some implementations, the one or more first visual assets 342 are those associated with the first workload 312, and are therefore the highest priority visual assets that are required to be downloaded, while the second visual assets 344 and the third visual assets 346 may be associated with the second and third ranked workloads of the priority ranking determined by the asset registry 320.

FIG. 4 shows the system 300 of FIG. 3 in a second operating condition 402. At the second operations condition 402, in at least some implementations, following the downloading of the initial visual asset bundle 340 (e.g. at first operating condition 302 of FIG. 3), the asset registry 320 may cause the downloading of one or more remaining visual assets 450 from the database of visual assets 330 to the user platform 314 at a reduced data transfer rate (e.g. in the background) while one or more workloads (e.g. the first workload 312) are being operated on the user platform 314.

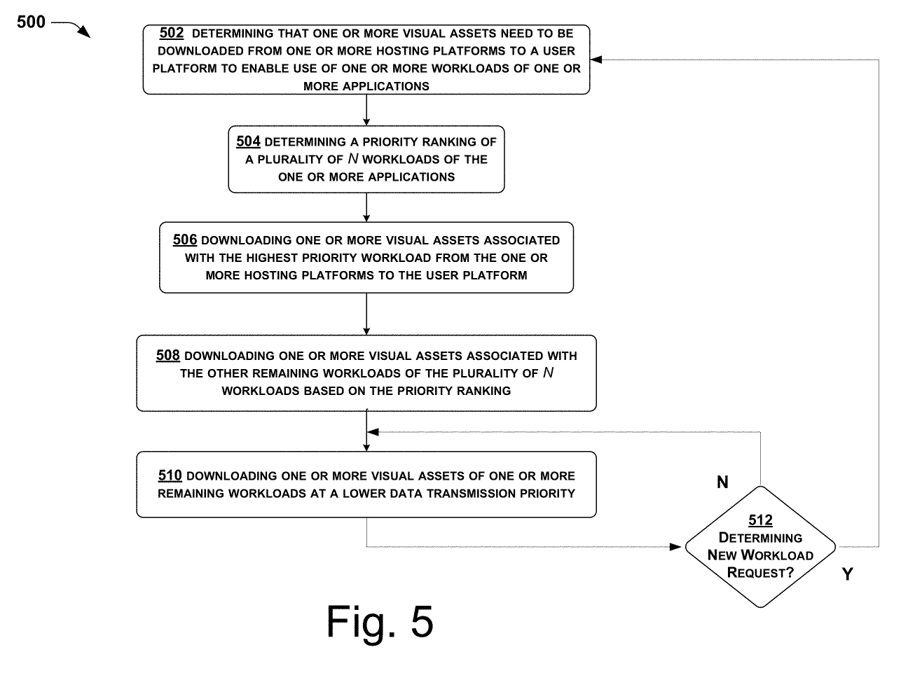

FIG. 5 shows another embodiment of a process 500 for downloading visual assets for applications. In this implementation, the process 500 includes determining that one or more visual assets need to be downloaded from one or more hosting platforms to a user platform to enable use of one or more workloads of one or more applications at 502. For example, as shown in FIG. 3, the determining at 502 may include determining that one or more visual assets (e.g. a collection of icons, symbols, visual objects, etc.) need to be downloaded to enable the first workload 312 (e.g. a word processing application, a personal assistant application (e.g. Cortana® by Microsoft, Siri® by Apple, Google Now by Google, etc.), an accounting application, a music playing application, or a finance management application) to be operated on the user platform 314.

The process 500 further includes determining a priority ranking of a plurality of n workloads of the one or more applications at 504. In at least some implementations, the determining of the priority ranking at 504 may include determining a priority ranking of the n workloads (e.g. three workloads), and then dividing the total number of workloads into subsets for eventual downloading. For example, in the implementation shown in FIGS. 3 and 4, the asset registry 320 determined the top three workloads, and then divided the visual assets to be downloaded into two subsets: the initial visual asset bundle 340 containing the visual assets 342, 344, 346 associated with the top three workloads (FIG. 3), and a second visual asset bundle containing the one or more remaining visual assets 450 for all remaining workloads (FIG. 4).

As further shown in FIG. 5, the process 500 further includes downloading one or more visual assets associated with the highest priority workload from the one or more hosting platforms to the user platform at 506. More specifically, as shown in FIG. 3, the downloading one or more visual assets associated with the highest priority workload at 506 may include downloading the first portion 343 of the initial visual asset bundle 340 containing the one or more first visual assets 342 to the user platform 314 to enable usage of the first workload 312.

The process 500 further includes downloading one or more visual assets associated with the other remaining workloads of the plurality of n workloads based on the priority ranking at 508. For example, referring again to FIG. 3, the downloading one or more visual assets associated with the other remaining workloads of the plurality of n workloads at 508 may include downloading the second portion 345 of the initial visual asset bundle 340 containing the one or more second visual assets 344 and the one or more third visual assets 346 to the user platform 314 to enable usage of the second and third highest priority workloads.

With continued reference to FIG. 5, in at least some implementations, the process 500 further includes downloading one or more visual assets of one or more remaining workloads at a lower data transmission priority (or data transmission rate) at 510. For example, in at least some implementations, downloading one or more visual assets of one or more remaining workloads at 501 includes the asset registry 320 of the one or more hosting platforms 305 downloading the remaining visual assets 450 (or at least a portion of the remaining visual assets) from the database of visual assets 330 to the user platform 314 in the background while a user operates the first workload 312 or other workloads on the user platform 314.

The process 500 further includes determining whether a new workload request has been received at 512. In at least some implementations, the determining at 512 may be performed simultaneously with the downloading of one or more visual assets of one or more remaining workloads at the lower data transmission priority at 510. Accordingly, while it is determined at 512 that no new workload request has been received, then the process 500 may continue to download the one or more visual assets of one or more remaining workloads at a lower data transmission priority at 510.

If it is determined, however, that a new workload request has been received at 512, then the process 500 returns to determining that one or more visual assets need to be downloaded from one or more hosting platforms to a user platform to enable use of one or more workloads of one or more applications at 502, and the above-noted operations of the process 500 may be repeated with the new workload request being handled as the highest priority workload.

For example, as the system 300 is operating in the second condition 402 shown in FIG. 4, while the remaining visual assets 450 (or a portion thereof) are being downloaded in the background (or at a lower data transmission priority or data transmission rate) to the user platform 314, a user may invoke a different workload (e.g. a different application, or a different workload of the same application as the first workload 312, etc.), and the different workload may require an immediate downloading of one or more visual assets associated with the different workload. Accordingly, while it is determined at 512 that no new workload request has been received, then the system 300 may continue to download the remaining visual assets 450 to the user platform 314.

Once it is determined at 512 that a new workload request has been received, however, the system 300 may reinitiate the process 500, and the process 500 may be repeated with the new workload being given highest priority so that the new workload is enabled on the user platform 314 as quickly as possible. In at least some implementations, the downloading of the one or more visual assets of the one or more remaining workloads at 510 may be suspended when it is determined at 512 that a new workload request has been received to avoid duplicative downloading operations. It will be appreciated that the determining of the priority ranking of the plurality of n workloads of the one or more applications at 504 during the second or subsequent performance of the process 500 may take into consideration whether the visual assets associated with one or more workloads has been recently downloaded (or updated) by a previous performance of the process 500 so that duplicative or unnecessary downloading of visual assets may be avoided. For example, if the visual assets associated with five workloads have just been downloaded to the user platform 314 within a specified period of time, then the determination of the priority ranking at 504 may elect to omit those five workloads from the determination of the priority ranking, and may instead determine the priority ranking of the plurality of n workloads of the one or more applications from the remaining workloads that have not yet been downloaded within the specified period of time.

In general, techniques and technologies disclosed herein for downloading visual assets for applications may be described in the general context of computer code or machine-useable instructions, including computer-executable instructions such as program modules, being executed by a computer or other device. Generally, program modules including routines, programs, objects, components, data structures, etc., refer to code that perform particular tasks or implement particular abstract data types. Various embodiments of the invention may be practiced in a variety of system configurations, including hand-held devices, consumer electronics, general-purpose computers, more specialty computing devices, etc. In addition, various embodiments of the invention may also be practiced in distributed computing environments (e.g. cloud-based computing systems) where tasks are performed by remote-processing devices that are linked through a communications network.

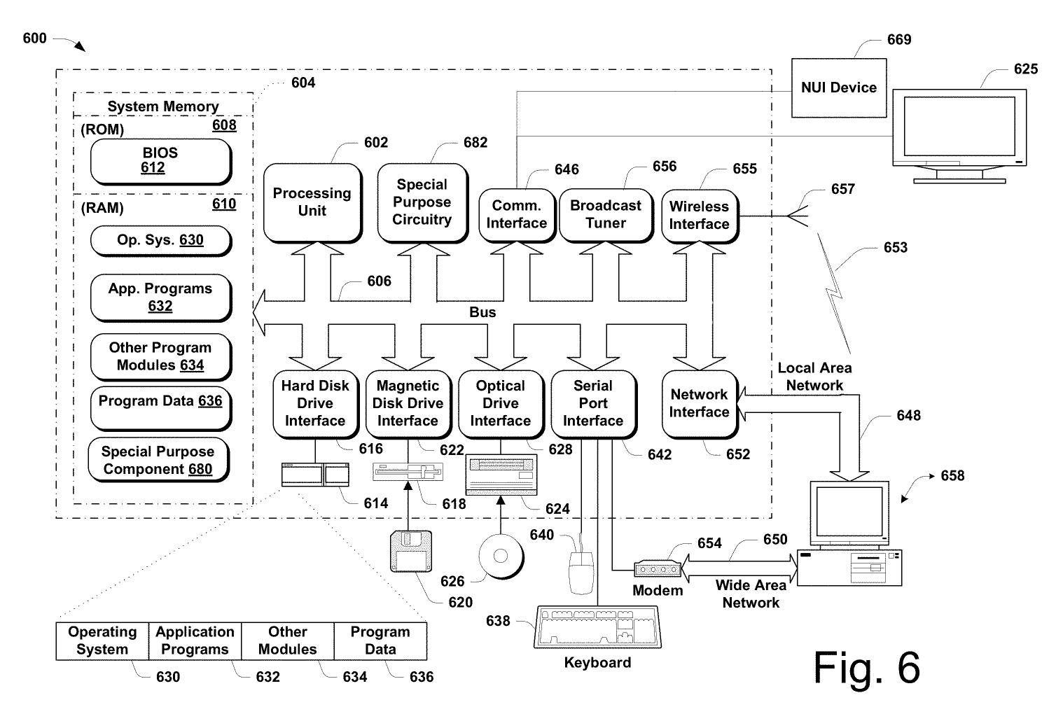

Furthermore, techniques and technologies disclosed herein for downloading visual assets for applications may be implemented on a wide variety of devices and platforms. For example, FIG. 6 shows an embodiment of a computer system 600 that may be employed for downloading visual assets for applications. As shown in FIG. 6, the example computer system environment 600 includes one or more processors (or processing units) 602, special purpose circuitry 682, memory 604, and a bus 606 that operatively couples various system components, including the memory 604, to the one or more processors 602 and special purpose circuitry 682 (e.g., Application Specific Integrated Circuitry (ASIC), Field Programmable Gate Array (FPGA), etc.).

The bus 606 may represent one or more of any of several types of bus structures, including a memory bus or memory controller, a peripheral bus, an accelerated graphics port, and a processor or local bus using any of a variety of bus architectures. In at least some implementations, the memory 604 includes read only memory (ROM) 608 and random access memory (RAM) 610. A basic input/output system (BIOS) 612, containing the basic routines that help to transfer information between elements within the system 600, such as during start-up, is stored in ROM 608.

The example system environment 600 further includes a hard disk drive 614 for reading from and writing to a hard disk (not shown), and is connected to the bus 606 via a hard disk driver interface 616 (e.g., a SCSI, ATA, or other type of interface). A magnetic disk drive 618 for reading from and writing to a removable magnetic disk 620, is connected to the system bus 606 via a magnetic disk drive interface 622. Similarly, an optical disk drive 624 for reading from or writing to a removable optical disk 626 such as a CD ROM, DVD, or other optical media, connected to the bus 606 via an optical drive interface 628. The drives and their associated computer-readable media may provide nonvolatile storage of computer readable instructions, data structures, program modules and other data for the system environment 600. Although the system environment 600 described herein employs a hard disk, a removable magnetic disk 620 and a removable optical disk 626, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used.

The computer-readable media included in the system memory 600 can be any available or suitable media, including volatile and nonvolatile media, and removable and non-removable media, and may be implemented in any method or technology suitable for storage of information such as computer-readable instructions, data structures, program modules, or other data. More specifically, suitable computer-readable media may include random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information. As used herein, the term “computer-readable media” is not intended to include transitory signals.

As further shown in FIG. 6, a number of program modules may be stored on the memory 604 (e.g., the ROM 608 or the RAM 610) including an operating system 630, one or more application programs 632, other program modules 634, and program data 636 (e.g., the data store 620, image data, audio data, three dimensional object models, etc.). Alternately, these program modules may be stored on other computer-readable media, including the hard disk, the magnetic disk 620, or the optical disk 626. For purposes of illustration, programs and other executable program components, such as the operating system 630, are illustrated in FIG. 6 as discrete blocks, although it is recognized that such programs and components reside at various times in different storage components of the system environment 600, and may be executed by the processor(s) 602 or the special purpose circuitry 682 of the system environment 600.

A user may enter commands and information into the system environment 600 through input devices such as a keyboard 638 and a pointing device 640. Other input devices (not shown) may include a microphone, joystick, game pad, satellite dish, scanner, or the like. Still other input devices, such as a Natural User Interface (NUI) device 669, or user interface 625, include or involve one or more aspects of a Natural User Interface (NUI) that enables a user to interact with the system environment 600 in a “natural” manner, free from artificial constraints imposed by conventional input devices such as mice, keyboards, remote controls, and the like. For example, in at least some embodiments, the NUI device 669 may rely on speech recognition, touch and stylus recognition, one or more biometric inputs, gesture recognition both on screen and adjacent to the screen, air gestures, head and eye (or gaze) tracking, voice and speech, vision, touch, hover, gestures, machine intelligence, as well as technologies for sensing brain activity using electric field sensing electrodes (EEG and related methods) to receive inputs. In addition, in at least some embodiments, an NUI may involve or incorporate one or more aspects of touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which provide a more natural interface.

These and other input devices are connected to the processing unit 602 and special purpose circuitry 682 through an interface 642 or a communication interface 646 (e.g. video adapter) that is coupled to the system bus 606. A user interface 625 (e.g., display, monitor, or any other user interface device) may be connected to the bus 606 via an interface, such as a video adapter 646. In addition, the system environment 600 may also include other peripheral output devices (not shown) such as speakers and printers.

The system environment 600 may operate in a networked environment using logical connections to one or more remote computers (or servers) 658. Such remote computers (or servers) 658 may be a personal computer, a server, a router, a network PC, a peer device or other common network node. The logical connections depicted in FIG. 6 include one or more of a local area network (LAN) 648 and a wide area network (WAN) 650. Such networking environments are commonplace in offices, enterprise-wide computer networks, intranets, and the Internet. In this embodiment, the system environment 600 also includes one or more broadcast tuners 656. The broadcast tuner 656 may receive broadcast signals directly (e.g., analog or digital cable transmissions fed directly into the tuner 656) or via a reception device (e.g., via an antenna 657, a satellite dish, etc.).

When used in a LAN networking environment, the system environment 600 may be connected to the local area network 648 through a network interface (or adapter) 652. When used in a WAN networking environment, the system environment 600 typically includes a modem 654 or other means (e.g., router) for establishing communications over the wide area network 650, such as the Internet. The modem 654, which may be internal or external, may be connected to the bus 606 via the serial port interface 642. Similarly, the system environment 600 may exchange (send or receive) wireless signals 653 with one or more remote devices using a wireless interface 655 coupled to a wireless communicator 657 (e.g., an antenna, a satellite dish, a transmitter, a receiver, a transceiver, a photoreceptor, a photodiode, an emitter, a receptor, etc.).

In a networked environment, program modules depicted relative to the system environment 600, or portions thereof, may be stored in the memory 604, or in a remote memory storage device. More specifically, as further shown in FIG. 6, a special purpose component 680 may be stored in the memory 604 of the system environment 600. The special purpose component 680 may be implemented using software, hardware, firmware, or any suitable combination thereof. In cooperation with the other components of the system environment 600, such as the processing unit 602 or the special purpose circuitry 682, the special purpose component 680 may be operable to perform one or more implementations of techniques described above (e.g., example process 200 of FIG. 2, process 500 of FIG. 5, etc.).

Generally, application programs and program modules executed on the system environment 600 may include routines, programs, objects, components, data structures, etc., for performing particular tasks or implementing particular abstract data types. These program modules and the like may be executed as a native code or may be downloaded and executed, such as in a virtual machine or other just-in-time compilation execution environments. Typically, the functionality of the program modules may be combined or distributed as desired in various implementations.

In view of the disclosure of techniques and technologies for downloading one or more visual assets as disclosed herein, a few representative embodiments are summarized below. It should be appreciated that the following summary of representative embodiments is not intended to be exhaustive of all possible embodiments, and that additional embodiments may be readily conceived from the disclosure of techniques and technologies provided herein.

For example, in at least some embodiments, a system for downloading visual assets may include a plurality of visual assets stored on at least one memory, the plurality of visual assets associated with a plurality of workloads; an asset registry including information regarding prior usage of the plurality of workloads, the asset registry being configured to: determine a priority ranking of a plurality of n workloads of the plurality of workloads based at least partially on the prior usage of the plurality of workloads, where n is less than a total number of workloads in the plurality of workloads; facilitate downloading of one or more visual assets associated with the plurality of n workloads based on the priority ranking; and facilitate downloading of one or more visual assets associated with one or more remaining workloads of the plurality of workloads at a reduced priority transmission rate compared with a nominal transmission rate associated with the downloading of the plurality of n workloads.

In at least some implementations, the plurality of visual assets includes a plurality of visual assets stored in a visual asset database. In other implementations, the plurality of visual assets includes a plurality of visual assets, each visual asset of the plurality of visual assets being part of an application stored in on the at least one memory. In further implementations, the plurality of visual assets includes a plurality of visual assets for use in a user interface portion of an application, the plurality of visual assets including at least one of an icon, a symbol, or a shape.

In at least some implementations, the asset registry including information regarding prior usage of the plurality of workloads includes an asset registry including information regarding prior usage of the plurality of workloads by at least one of a particular user or a group of previous users.

In further implementations, the asset registry configured to determine a priority ranking of a plurality of n workloads of the plurality of workloads based at least partially on the prior usage of the plurality of workloads includes an asset registry configured to determine a priority ranking of a plurality of n workloads of the plurality of workloads based on at least one of a frequency of usage of the plurality of n workloads or a volume of usage of the plurality of n workloads. In still other implementations, the asset registry configured to determine a priority ranking of a plurality of n workloads of the plurality of workloads based at least partially on the prior usage of the plurality of workloads includes an asset registry configured to determine a priority ranking of a plurality of n workloads of the plurality of workloads based on one or more patterns of usage of the plurality of n workloads.

In additional implementations, the asset registry configured to facilitate downloading of one or more visual assets associated with the plurality of n workloads based on the priority ranking includes an asset registry configured to: facilitate downloading of one or more visual assets associated with a highest priority workload of the plurality of n workloads based on the priority ranking; and facilitate downloading of one or more visual assets associated with one or more other workloads of the plurality of n workloads based on the priority ranking.

In still further implementations, the asset registry configured to facilitate downloading of one or more visual assets associated with the plurality of n workloads based on the priority ranking includes an asset registry configured to facilitate downloading of a visual asset bundle containing the one or more visual assets associated with the plurality of n workloads based on the priority ranking. In addition, in at least some implementations, the asset registry configured to facilitate downloading of a visual asset bundle containing the one or more visual assets associated with the plurality of n workloads based on the priority ranking includes an asset registry configured to facilitate downloading of a visual asset bundle, including facilitating downloading of one or more visual assets associated with a highest priority workload based on the priority ranking, and facilitating downloading of one or more visual assets associated with n−1 other workloads of the plurality of n workloads based on the priority ranking.

In other implementations, the asset registry configured to facilitate downloading of one or more visual assets associated with one or more remaining workloads of the plurality of workloads at a reduced priority transmission rate compared with a nominal transmission rate associated with the downloading of the plurality of n workloads includes an asset registry configured to facilitate downloading of one or more visual assets associated with one or more remaining workloads of the plurality of workloads at a background transmission rate compared with a normal transmission rate associated with the downloading of the plurality of n workloads.

Alternately, in at least some implementations, a system for downloading visual assets includes a control component including at least one processing component; at least one memory operatively coupled to the control component; a plurality of visual assets stored on the at least one memory, each visual asset of the plurality of visual assets being associated with at least one workload of a plurality of workloads; and a registry stored on the at least one memory, the registry including information regarding prior usage of the plurality of workloads; wherein the control component is configured to: determine a need to download one or more visual assets associated with the plurality of workloads; determine a priority ranking of a plurality of n workloads of the plurality of workloads based at least partially on the prior usage of the plurality of workloads, where n is less than a total number of workloads in the plurality of workloads; download one or more visual assets associated with the plurality of n workloads based on the priority ranking at a nominal transmission rate; and download one or more visual assets associated with one or more remaining workloads of the plurality of workloads at a reduced priority transmission rate compared with the nominal transmission rate associated with the downloading of the plurality of n workloads.

In addition, in still other implementations, each workload of the plurality of workloads is associated with at least one application of a plurality of applications stored on the at least one memory. In further implementations, the asset registry including information regarding prior usage of the plurality of workloads comprises an asset registry including information regarding prior usage of the plurality of workloads by at least one of a particular user or a group of previous users. And in other implementations, the control component configured to determine a need to download one or more visual assets associated with the plurality of workloads includes a control component configured to determine a need to download one or more visual assets based on receiving a request via one or more networks to use an application associated with the plurality of workloads.

Additionally, in at least some implementations, the control component configured to determine a priority ranking of a plurality of n workloads of the plurality of workloads based at least partially on the prior usage of the plurality of workloads includes a control component configured to determine a priority ranking of a plurality of n workloads of the plurality of workloads based on at least one of a frequency of usage of the plurality of workloads or a volume of usage of the plurality of workloads.

In further implementations, the control component configured to determine a priority ranking of a plurality of n workloads of the plurality of workloads based at least partially on the prior usage of the plurality of workloads includes a control component configured to determine a priority ranking of a plurality of n workloads of the plurality of workloads based on one or more patterns of usage of the plurality of workloads. In some implementations, the control component configured to download one or more visual assets associated with the plurality of n workloads based on the priority ranking includes a control component configured to download a visual asset bundle containing the one or more visual assets associated with the plurality of n workloads based on the priority ranking. And in still other implementations, the control component configured to download one or more visual assets associated with one or more remaining workloads of the plurality of workloads at a reduced priority transmission rate compared with a nominal transmission rate associated with the downloading of the plurality of n workloads includes a control component configured to download one or more visual assets associated with one or more remaining workloads of the plurality of workloads at a background transmission rate compared with a normal transmission rate associated with the downloading of the plurality of n workloads.

In still further implementations, one or more computer-readable media bearing one or more instructions that, when executed by one or more processing components, perform operations for downloading visual assets, the operations comprising: determining a need to download one or more visual assets associated with a plurality of workloads of one or more applications; determining a priority ranking of a plurality of n workloads of the plurality of workloads based at least partially on prior usage of the plurality of workloads, where n is less than a total number of workloads in the plurality of workloads; downloading one or more visual assets associated with the plurality of n workloads based on the priority ranking at a nominal transmission rate; and downloading one or more visual assets associated with one or more remaining workloads of the plurality of workloads at a reduced priority transmission rate compared with the nominal transmission rate associated with the downloading of the plurality of n workloads.

### CONCLUSION

Those skilled in the art will recognize that some aspects of the embodiments disclosed herein can be implemented in standard integrated circuits, and also as one or more computer programs running on one or more computers, and also as one or more software programs running on one or more processors, and also as firmware, as well as virtually any combination thereof. It will be further understood that designing the circuitry and/or writing the code for the software and/or firmware could be accomplished by a person skilled in the art in light of the teachings and explanations of this disclosure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. It will be appreciated that the embodiments of techniques and technologies described above are not exhaustive of all possible embodiments considered to be within the scope of the present disclosure, and that additional embodiments may be conceived based on the subject matter disclosed herein. For example, in alternate embodiments one or more elements or components of the techniques and technologies described above may be re-arranged, re-ordered, modified, or even omitted to provide additional embodiments that are still considered to be within the scope of the present disclosure.

Alternately, or in addition, the techniques and technologies described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-On-a-Chip systems (SOCs), Complex Programmable Logic Devices (CPLDs), etc. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Although the subject matter has been described in language specific to structural features and/or acts, it is to be understood that the subject matter defined in the appended claims is not necessarily limited to the specific features or acts described. Rather, the specific features and acts described above are disclosed as examples of implementing the claims and other equivalent features and acts are intended to be within the scope of the claims. The various embodiments and implementations described above are provided by way of illustration only and should not be construed as limiting various modifications and changes that may be made to the embodiments and implementations described above without departing from the spirit and scope of the disclosure.

What is claimed is:

1. A system for downloading visual assets, comprising:
a plurality of visual assets stored on at least one memory, the plurality of visual assets associated with a plurality of workloads;
an asset registry including information regarding prior usage of the plurality of workloads, the asset registry being configured to:
determine a priority ranking of a plurality of n workloads of the plurality of workloads based at least partially on the prior usage of the plurality of workloads, where n is less than a total number of workloads in the plurality of workloads;
facilitate downloading of one or more visual assets associated with the plurality of n workloads based on the priority ranking; and
facilitate downloading of one or more visual assets associated with one or more remaining workloads of the plurality of workloads at a reduced priority transmission rate compared with a nominal transmission rate associated with the downloading of the plurality of n workloads.

2. The system of claim 1, wherein the plurality of visual assets comprises:
a plurality of visual assets stored in a visual asset database.

3. The system of claim 1, wherein the plurality of visual assets comprises:
a plurality of visual assets, each visual asset of the plurality of visual assets being part of an application stored in on the at least one memory.

4. The system of claim 1, wherein the plurality of visual assets comprises:
a plurality of visual assets for use in a user interface portion of an application, the plurality of visual assets including at least one of an icon, a symbol, or a shape.

5. The system of claim 1, wherein the asset registry including information regarding prior usage of the plurality of workloads comprises:
an asset registry including information regarding prior usage of the plurality of workloads by at least one of a particular user or a group of previous users.

6. The system of claim 1, wherein the asset registry configured to determine a priority ranking of a plurality of n workloads of the plurality of workloads based at least partially on the prior usage of the plurality of workloads comprises:
an asset registry configured to determine a priority ranking of a plurality of n workloads of the plurality of workloads based on at least one of a frequency of usage of the plurality of n workloads or a volume of usage of the plurality of n workloads.

7. The system of claim 1, wherein the asset registry configured to determine a priority ranking of a plurality of n workloads of the plurality of workloads based at least partially on the prior usage of the plurality of workloads comprises:
an asset registry configured to determine a priority ranking of a plurality of n workloads of the plurality of workloads based on one or more patterns of usage of the plurality of n workloads.

8. The system of claim 1, wherein the asset registry configured to facilitate downloading of one or more visual assets associated with the plurality of n workloads based on the priority ranking comprises:
an asset registry configured to:
facilitate downloading of one or more visual assets associated with a highest priority workload of the plurality of n workloads based on the priority ranking; and
facilitate downloading of one or more visual assets associated with one or more other workloads of the plurality of n workloads based on the priority ranking.

9. The system of claim 1, wherein the asset registry configured to facilitate downloading of one or more visual assets associated with the plurality of n workloads based on the priority ranking comprises:
an asset registry configured to facilitate downloading of a visual asset bundle containing the one or more visual assets associated with the plurality of n workloads based on the priority ranking.

10. The system of claim 9, wherein the asset registry configured to facilitate downloading of a visual asset bundle containing the one or more visual assets associated with the plurality of n workloads based on the priority ranking comprises:
an asset registry configured to facilitate downloading of a visual asset bundle, including facilitating downloading of one or more visual assets associated with a highest priority workload based on the priority ranking, and facilitating downloading of one or more visual assets associated with n−1 other workloads of the plurality of n workloads based on the priority ranking.

11. The system of claim 1, wherein the asset registry configured to facilitate downloading of one or more visual assets associated with one or more remaining workloads of the plurality of workloads at a reduced priority transmission rate compared with a nominal transmission rate associated with the downloading of the plurality of n workloads comprises:
an asset registry configured to facilitate downloading of one or more visual assets associated with one or more remaining workloads of the plurality of workloads at a background transmission rate compared with a normal transmission rate associated with the downloading of the plurality of n workloads.

12. A system for downloading visual assets, comprising:
a control component including at least one processing component;
at least one memory operatively coupled to the control component;
a plurality of visual assets stored on the at least one memory, each visual asset of the plurality of visual assets being associated with at least one workload of a plurality of workloads; and
a registry stored on the at least one memory, the registry including information regarding prior usage of the plurality of workloads;
wherein the control component is configured to:
determine a need to download one or more visual assets associated with the plurality of workloads;
determine a priority ranking of a plurality of n workloads of the plurality of workloads based at least partially on the prior usage of the plurality of workloads, where n is less than a total number of workloads in the plurality of workloads;
download one or more visual assets associated with the plurality of n workloads based on the priority ranking at a nominal transmission rate; and
download one or more visual assets associated with one or more remaining workloads of the plurality of workloads at a reduced priority transmission rate compared with the nominal transmission rate associated with the downloading of the plurality of n workloads.

13. The system of claim 12, wherein each workload of the plurality of workloads is associated with at least one application of a plurality of applications stored on the at least one memory.

14. The system of claim 12, wherein the asset registry including information regarding prior usage of the plurality of workloads comprises:
an asset registry including information regarding prior usage of the plurality of workloads by at least one of a particular user or a group of previous users.

15. The system of claim 12, wherein the control component configured to determine a need to download one or more visual assets associated with the plurality of workloads comprises:
a control component configured to determine a need to download one or more visual assets based on receiving a request via one or more networks to use an application associated with the plurality of workloads.

16. The system of claim 12, wherein the control component configured to determine a priority ranking of a plurality of n workloads of the plurality of workloads based at least partially on the prior usage of the plurality of workloads comprises:
a control component configured to determine a priority ranking of a plurality of n workloads of the plurality of workloads based on at least one of a frequency of usage of the plurality of workloads or a volume of usage of the plurality of workloads.

17. The system of claim 12, wherein the control component configured to determine a priority ranking of a plurality of n workloads of the plurality of workloads based at least partially on the prior usage of the plurality of workloads comprises:
a control component configured to determine a priority ranking of a plurality of n workloads of the plurality of workloads based on one or more patterns of usage of the plurality of workloads.

18. The system of claim 12, wherein the control component configured to download one or more visual assets associated with the plurality of n workloads based on the priority ranking comprises:
a control component configured to download a visual asset bundle containing the one or more visual assets associated with the plurality of n workloads based on the priority ranking.

19. The system of claim 12, wherein the control component configured to download one or more visual assets associated with one or more remaining workloads of the plurality of workloads at a reduced priority transmission rate compared with a nominal transmission rate associated with the downloading of the plurality of n workloads comprises:
a control component configured to download one or more visual assets associated with one or more remaining workloads of the plurality of workloads at a background transmission rate compared with a normal transmission rate associated with the downloading of the plurality of n workloads.

20. One or more computer-readable media bearing one or more instructions that, when executed by one or more processing components, perform operations for downloading visual assets, the operations comprising:
determining a need to download one or more visual assets associated with a plurality of workloads of one or more applications;
determining a priority ranking of a plurality of n workloads of the plurality of workloads based at least partially on prior usage of the plurality of workloads, where n is less than a total number of workloads in the plurality of workloads;
downloading one or more visual assets associated with the plurality of n workloads based on the priority ranking at a nominal transmission rate; and
downloading one or more visual assets associated with one or more remaining workloads of the plurality of workloads at a reduced priority transmission rate compared with the nominal transmission rate associated with the downloading of the plurality of n workloads.
